(19) United States
(12) Patent Application Publication
(10) Pub. No.: US 2024/0160288 A1
(43) Pub. Date: May 16, 2024

(54) NEURONAL TO MEMORY DEVICE COMMUNICATION

(71) Applicant: Micron Technology, Inc., Boise, ID (US)

(72) Inventors: John D. Hopkins, Milpitas, CA (US); Mohad Baboli, Boise, ID (US)

(21) Appl. No.: 18/498,422

(22) Filed: Oct. 31, 2023

Related U.S. Application Data
(60) Provisional application No. 63/425,627, filed on Nov. 15, 2022.

(51) Int. Cl. G06F 3/01; G06F 21/31; G06F 21/84

(52) U.S. Cl. CPC G06F 3/015; G06F 21/31; G06F 21/84

(57) ABSTRACT

Methods, systems, and apparatus for neuronal to memory device communication are described. An apparatus can include a memory device and a processing device communicatively coupled to the memory device. The processing device can receive neuronal map data associated with at least one image, determine that the neuronal map data is associated with the at least one image, and display the at least one image in response to the determination.

### PRIORITY INFORMATION

This application claims the benefit of U.S. Provisional Application No. 63/425,627, filed on Nov. 15, 2022, the contents of which are incorporated herein by reference.

### TECHNICAL FIELD

The present disclosure relates generally to apparatuses, non-transitory machine-readable media, and methods associated with neuronal to memory device communication.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices. The computing device can, in some examples, include an augmented reality (AR) computing device that displays an image or text.

### BRIEF DESCRIPTION OF THE DRAWINGS

FIG. 1 is a functional diagram representing a memory system including a neuronal component in accordance with a number of embodiments of the present disclosure.

FIG. 2 is a functional diagram representing a neuronal map for performing a training operation in accordance with a number of embodiments of the present disclosure.

FIG. 3 is functional diagram of a processing device and a computing device for performing a neuronal to memory device communication in accordance with embodiments of the present disclosure.

FIG. 4 is a flow diagram representing an example method for neuronal to memory device communication in accordance with a number of embodiments of the present disclosure.

FIG. 5 is an example method for neuronal to memory device communication in accordance with a number of embodiments of the present disclosure.

FIG. 6 illustrates a diagram of a computing system for neuronal to memory device communication in accordance with a number of embodiments of the present disclosure.

### DETAILED DESCRIPTION

Apparatuses, systems, and methods related to neuronal to memory device communication are described. Communicating via text or images is increasingly more common as computing devices are used for communication. The communication can be generated by neuronal maps. The neuronal maps can be created from signals arising from neurons of a user's brain that are translated into viewable text. In this way, the generation of text can be more automated and faster in order to avoid delaying communication by use of a keyboard or other device for typing or selecting letters and/or words. A device physically connected to regions of the brain using wires can detect and map electrical signals from neurons within the brain to create a signature of neuronal activity. The neuronal signature can correspond to brain activity of the user and each signature can be interpreted or trained so as to result in an output of a viewable text on another device controlled by the user, such as virtual reality glasses, cell phones, etc.

The neuronal signature can include a particular number and/or pattern of neurons firing together or in a particular sequence. The neuronal signature can be correlated with a particular text or image such that the detection of the neuronal signature results in the particular text or image being provided as an output, such as in a display or as a result of the neuronal signature. The output of the text and/or image can be released to an external computing device by providing a password or command. In some examples, the command is a particular key to be typed or a particular word to type into the memory device to command the image or text to be displayed. The password or command can include a neuronal signature associated with the password or command. For example, a first neuronal signature can be correlated with text or an image and a second neuronal signature can be correlated with a password that allows the text or image to be output as a result. In the absence of the password or command being provided, the text or image can be prevented from being provided as an output. In this way, not all neuronal activity will be provided as a result or output and the ability to correlate neuronal activity and/or neuronal signatures with texts and images can be controllable and customized to prevent neuronal activity that is private to remain private.

Examples of the present disclosure can include an apparatus including a memory device and a processing device communicatively coupled to the memory device. The processing device can receive neuronal map data associated with at least one image. The processing device can determine that the neuronal map data is associated with the at least one image. The processing device can display the at least one image in response to the determination.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context.

As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

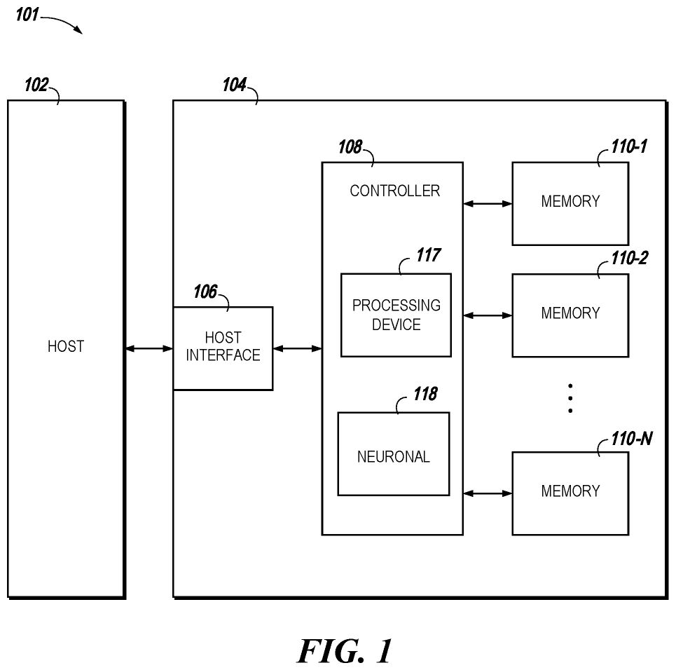

FIG. 1 is a block diagram of an apparatus in the form of a computing system 101 comprising a memory system 104 in accordance with a number of embodiments of the present disclosure. As used herein, a memory system, controller, and/or memory device may separately be an “apparatus”.

Memory system 104 can be, for example, a solid state drive (SSD). In the embodiment illustrated in FIG. 1, memory system 104 includes a host interface 106, a memory (e.g., a number of memory devices 110-1, 110-2, . . . , 110-N), and a controller 108 (e.g., an SSD controller) coupled to physical host interface 106 and memory devices 110-1, 110-2, . . . , 110-N.

Memory devices 110-1, 110-2, . . . , 110-N can include, for example, a number of non-volatile memory arrays (e.g., arrays of non-volatile memory cells). For instance, memory devices 110-1, 110-2, . . . , 110-N can include a number of memory arrays analogous to memory array 331 previously described in connection with FIG. 1.

In some embodiments, the memory devices 110-1, . . . , 110-N can include a number of arrays of memory cells (e.g., non-volatile memory cells). The arrays can be flash arrays with a NAND architecture, for example. However, embodiments are not limited to a particular type of memory array or array architecture. As described above in connection with FIG. 1, the memory cells can be grouped, for instance, into a number of blocks including a number of physical pages of memory cells. In a number of embodiments, a block refers to a group of memory cells that are erased together as a unit. A number of blocks can be included in a plane of memory cells and an array can include a number of planes. As one example, a memory device may be configured to store 8 KB (kilobytes) of user data per page, 128 pages of user data per block, 2048 blocks per plane, and 16 planes per device.

In operation, data can be written to and/or read from a memory device of a memory system (e.g., memory devices 110-1, . . . , 110-N of memory system 104) as a page of data, for example. As such, a page of data can be referred to as a data transfer size of the memory system. Data can be transferred to/from a host 102) in data segments referred to as sectors (e.g., host sectors). As such, a sector of data can be referred to as a data transfer size of the host. In some embodiments, NAND blocks may be referred to as erase blocks, with blocks being a unit of erasure and pages being a measure of reads and/or writes.

Host interface 106 can be used to communicate information between memory system 104 and another device such as a host 102. Host 102 can include a memory access device (e.g., a processor). As used herein, “a processor” can intend a number of processors, such as a parallel processing system, a number of coprocessors, etc. Example hosts can include personal laptop computers, desktop computers, digital cameras, digital recording and playback devices, mobile (e.g., smart) phones, PDAs, memory card readers, interface hubs, and the like.

The host system 102 uses the memory system 104, for example, to perform a command. As used herein, the term “command” refers to an instruction from a memory system to perform a task or function. For example, the memory controller 108 of the memory system 104 can cause a processing device 117 to perform a task based on a given command. In some embodiment, a command can include a memory request. That is, a command can be a request to read and/or write data from and/or to the memory device 110-1, 110-2, 110-N. The host system 102 may, for example, write data to the memory system 104 and read data from the memory system 104 based on a command (e.g., memory request).

Host interface 106 can be in the form of a standardized physical interface. For example, when memory system 104 is used for information storage in computing system 101, host interface 106 can be a serial advanced technology attachment (SATA) physical interface, a peripheral component interconnect express (PCIe) physical interface, or a universal serial bus (USB) physical interface, among other physical connectors and/or interfaces. In general, however, host interface 106 can provide an interface for passing control, address, information (e.g., data), and other signals between memory system 104 and a host (e.g., host 102) having compatible receptors for host interface 106.

Controller 108 can include, for example, control circuitry and/or logic (e.g., hardware and firmware). Controller 108 can be included on the same physical device (e.g., the same die) as memories 110-1, 110-2, . . . , 110-N. For example, controller 108 can be an application specific integrated circuit (ASIC) coupled to a printed circuit board including physical host interface 106 and memories 110-1, 110-2, . . . , 110-N. Alternatively, controller 108 can be included on a separate physical device that is communicatively coupled to the physical device that includes memories 110-1, 110-2, . . . , 110-N. In a number of embodiments, components of controller 108 can be spread across multiple physical devices (e.g., some components on the same die as the memory, and some components on a different die, module, or board) as a distributed controller.

Controller 108 can communicate with memory devices 110-1, 110-2, . . . , 110-N to sense (e.g., read), program (e.g., write), and/or erase information, among other operations. Controller 108 can have circuitry that may be a number of integrated circuits and/or discrete components. In a number of embodiments, the circuitry in controller 108 may include control circuitry for controlling access across memory devices 110-1, 110-2, . . . , 110-N and/or circuitry for providing a translation layer (e.g., a flash translation layer) between host 102 and memory system 104.

The controller 108 can include a neuronal component (“NEURONAL”) 118. The neuronal component 118 can include hardware and/or software used to detect neuronal activity of a brain of a user and store and/or send neuronal map data based on the neuronal activity to additional elements of the memory system 104. The neuronal map can include a number of configurations of neuronal activity of a person. The neuronal component 118, in some examples, can be used to analyze the neuronal activity and/or neuronal map data to determine to which text and/or image the neuronal map data corresponds based on a number of training operations. For example, a training operation can include providing a text to the user and recording the neuronal activity of the brain. The text and the recorded neuronal activity can then be correlated and stored in a database. The number of training operations can train the same text and/or image a quantity of times based on a threshold quantity that ensures reliability or confidence in the correlations. Any number of training operations using any number of texts and/or images can be used in order to provide a thorough and complete database of neuronal activity and text/image correlations in order to determine a text/image from a recorded neuronal activity.

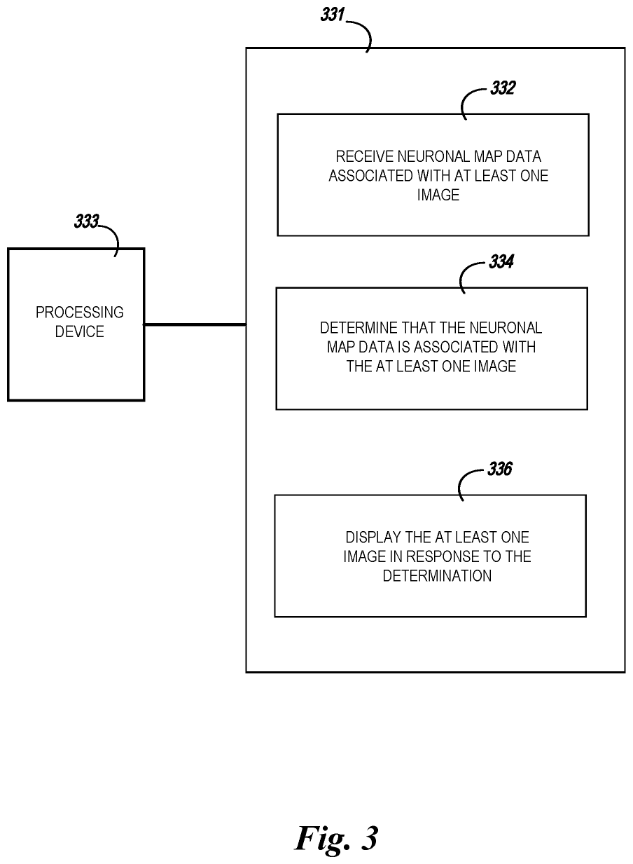

Controller 108 can control operation of a dedicated region, such as a block addressing portion, of each respective memory device 110-1, 110-2, . . . , 110-N as (e.g., configure a portion of each respective memory devices 110-1, 110-2, . . . , 110-N to operate as) a static (e.g., dedicated) single level cell (SLC) cache and/or a dynamic SLC cache. For example, a portion of each respective memory device 110-1, 110-2, . . . , 110-N can be configured to operate as a static cache in SLC mode and/or a dynamic cache in SLC mode. This portion of each respective memory device 110-1, 110-2, . . . , 110-N can be, for example, a first plurality of blocks (e.g., physical blocks) of memory cells in each respective memory, as will be further described herein (e.g., in connection with FIG. 3), and may be referred to herein as a first portion of the memory. In addition, portions of each respective memory device 110-1, 110-2, . . . , 110-N can include a second plurality of blocks, a third plurality of blocks, etc.

The second portion of each respective memory 110-1, 110-2, . . . , 110-N can be, for example, a second plurality of blocks (e.g., physical blocks) of memory cells in each respective memory, as will be further described. Controller 108 can perform erase operations, as well as program and sense operations, on the cells of the second portion in SLC or XLC mode.

The size of the second portion of each respective memory 110-1, 110-2, . . . , 110-N can correspond to the quantity of memory cells used by that memory to program data stored in the SLCs of the memory to the XLCs of the memory (e.g., to fold the SLC data to the XLCs). Generally, the size of the first portion is small as compared to the whole drive density.

The embodiment illustrated in FIG. 1 can include additional circuitry, logic, and/or components not illustrated so as not to obscure embodiments of the present disclosure. For example, memory device 104 can include address circuitry to latch address signals provided over I/O connectors through I/O circuitry. Address signals can be received and decoded by a row decoders and column decoders, to access memories 110-1, 110-2, . . . , 110-N.

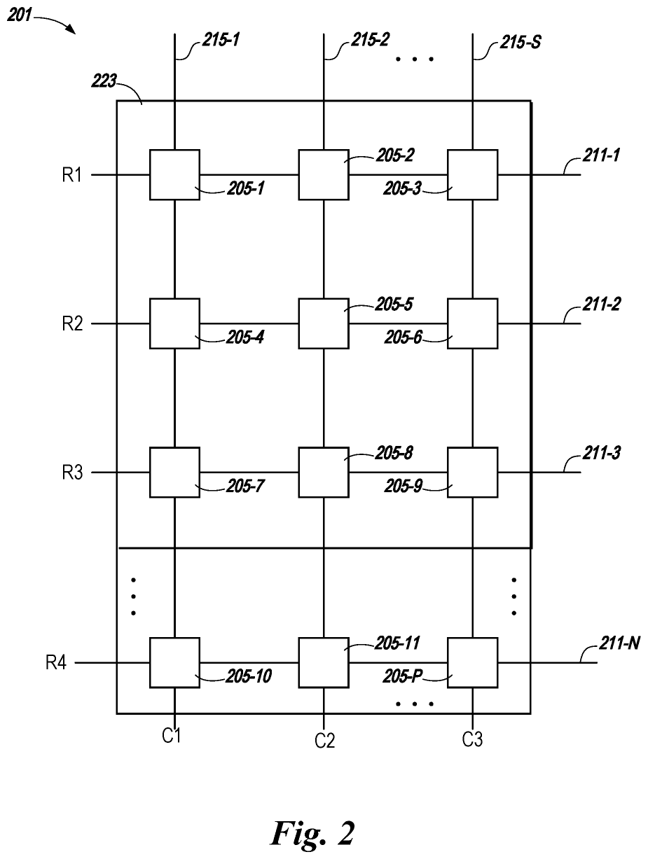

FIG. 2 is a functional diagram 201 representing a neuronal map for performing a training operation in accordance with a number of embodiments of the present disclosure. The functional diagram 201 illustrates a plurality of neurons 205-1 through 205-P that are shown in a plurality of rows of neurons 211-1, 211-2, 211-3, . . . , 211-N (hereinafter referred to collectively as plurality of rows 211) and a plurality of columns of neurons 215-1, 215-2, . . . , 215-S (hereinafter referred to collectively as plurality of columns of neurons 215). While a brain contains a much larger number of neurons, the functional diagram 201 is used for illustrative purposes as an example of how to record a neuronal map including a plurality of neurons 205 and how to use the neuronal maps to determine outputs based on each of the neuronal maps. Further, while neurons are not arranged in rows or columns in such an organized way, per se, the illustration is merely for ease of description and reference in FIG. 2.

As an example, a particular pattern of neurons firing can indicate a particular text and/or image being imagined, thought of, perceived, or currently being viewed. The particular pattern of neurons being fired can be recorded and/or detected during a number of training operations in order to determine which neuronal map of firing neurons is associated with which text and/or image. In one example, a set of neurons including neurons 205-1, 205-3, and 205-4 can be firing and can be the neuronal map associated with the word “hello.” During a training operation, the word “hello” can be displayed for the user to view and electrical signals from neurons in the brain can be concurrently detected with the display and the word “hello” can be associated with the neuronal map generated from the electrical signals.

Any number of words and/or images can be repeatedly presented to the user while recording the electrical signals of neurons of the brain of the user in order to associate neuronal maps with the text and/or image. In this way, a memory device can be trained to associate a neuronal map with a text and/or image with a particular degree of accuracy or confidence depending on the number of training operations and the number of errors and/or correct associations during the training operations. Once a threshold quantity of accurate associations is made, the memory system can associate electrical signals generated from neurons of the user's brain when not displaying the text and/or image to the brain or training the brain using the stimuli of the text/image.

In some examples, for verification purposes, a particular text or image associated with a particular neuronal map can be used as a password and/or command to confirm to use the neuronal map to display the associated text and/or image. For example, in the absence of the neuronal map used as a password being received, any other associations of neuronal maps and text/images would not be displayed or used by the memory system. In this way, unauthorized or undesired texts and images that were perceived or viewed by the user's brain would not be transmitted as an associated image or text. The password associated with the neuronal map could include a number of neuronal maps representing a number of texts or images that occur in a particular sequence. For example, a first neuronal map associated with an image of a dog could be received and a second neuronal map associated with the word “tiger” could subsequently be received. A subsequent third neuronal map associated with an image of a pencil could then be received. The dog image and subsequent word tiger could be the password and when the first neuronal map and the second neuronal map are received in that order, the display or transmission of the associated text or image of the third neuronal map could be used. While an example is given here, any number of combinations or quantity of neuronal maps can be used. For example, it could be a sequence of one, two, three, etc. words, or one, two, three, etc. images or a combination of words and/or images to designate as the password or command.

In some examples, additional neuronal map data associated with a password or permission to display the at least one image can be received prior to displaying the at least one image. The additional neuronal map data can be associated with a particular sequence of images.

FIG. 3 is functional diagram of a processing device 333 and a computing device 331 for performing a neuronal to memory device communication in accordance with embodiments of the present disclosure. The apparatus illustrated in FIG. 3 can be a server or a computing device (among others) and can include the processing device 333 (e.g., a processing resource). The apparatus can further include the memory device 331 (e.g., a non-transitory MRM), on which may be stored instructions, such as instructions 332, 334, 336. The device, in some examples, may be analogous to the device described with respect to FIG. 1 including processing device 117 and memory device(s) 110. Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory device 331 may be electronic, magnetic, optical, or other physical storage device that stores executable instructions. Thus, the memory device 331 may be, for example, non-volatile or volatile memory. In some examples, the memory device 331 is a non-transitory MRM comprising RAM, an Electrically-Erasable Programmable ROM (EEPROM), a storage drive, an optical disc, and the like. The memory device 331 may be disposed within a controller and/or computing device. In this example, the executable instructions 332, 334, 336 can be “installed” on the device. Additionally, and/or alternatively, the memory device 331 can be a portable, external or remote storage medium, for example, that allows the system to download the instructions 332, 334, 336 from the portable/external/remote storage medium. In this situation, the executable instructions may be part of an “installation package”. As described herein, the memory device 331 can be encoded with executable instructions for sale of virtual goods based on physical location.

The instructions 332, when executed by a processing device such as the processing device 333 can include instructions to receive neuronal map data associated with at least one image. The neuronal map data can be generated through recording of electrical signals from a user's brain. The electrical signals can be indicative of a neuron or a group of neurons firing in the user's brain. In some examples, an electroencephalography (EEG) can be used to measure the brain waves. EEG can include placing small detectors, called electrodes, onto a user's scalp using a cap and/or a headset. The EEG measures electrical activity of groups of neurons that transmit similar electrical signals at the same time by creating a recording referred to as an electroencephalogram.

The instructions 334, when executed by a processing device such as the processing device 333, can include instructions to determine that the neuronal map data is associated with the at least one image. The determination can be based on a number of training operations that were previously performed, as is described above in association with FIG. 2. For example, a database from the training operations can be generated and stored and the associations between particular neuronal maps and particular images can be located in the database and used to make the determination.

The instructions 336, when executed by a processing device such as the processing device 333, can include instructions to display the at least one image in response to the determination. Further, in some examples, the at least one image can be displayed in response to receiving a neuronal map indicative of a password or command indicating to display the image, as is described above. In the absence of the neuronal map associated with the password or command, the image may not be displayed.

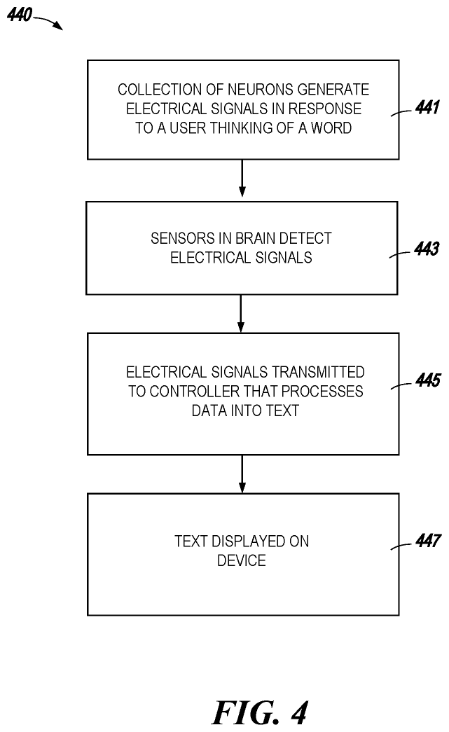

FIG. 4 illustrates an example flow diagram 440 associated with neuronal to memory device communication in accordance with a number of embodiments of the present disclosure. The example diagram 440 can be a method that can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by the neuronal component 118 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 441, a collection of neurons can generate electrical signals in response to a user thinking of a word. The collection of neurons can be across an entire brain or, in some examples, limited to particular regions or portions of the brain, such as areas designated for speech recognition, speech development, emotional recognition, emotional development, etc.

At block 443, sensors in a brain of the collection of neurons can detect the electrical signals. The electrical signals can be recorded by sensors that are implanted on the surface or near the surface of the collection of neurons in a brain of the user. The electrical signals can be detected using a near infrared (IR) sensor system.

At block 445, the electrical signals can be transmitted to a controller that processes the data into text. The controller can access a database that includes associations between the electrical signals (e.g., the neuronal maps described above) and text. The associations can be generated for the database by performing a number of training operations, as described above. The training operations can display the text to the user and then record the electrical signals associated with viewing of the displayed text. A repeated number of training operations for a particular word can develop an averaged neuronal map for that particular word or a general neuronal map with a threshold degree of confidence or accuracy that the neuronal map is indeed associated with the particular text. In some examples, the data can be sent to a processor that interprets the data using software and/or other analytic tools.

At block 447, the text can be displayed on a device. In some examples, the device is a phone, a laptop, a computing device, a virtual reality device, etc. In the example of the virtual reality device, the text can be displayed on the virtual reality device for viewing by the user and/or others interacting with the virtual reality device and the user. For example, the text can be displayed in the user's field of view on the display of the virtual reality device.

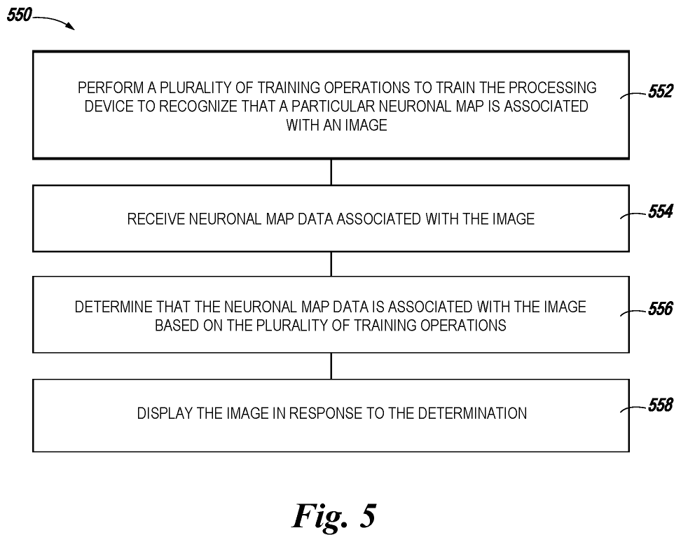

FIG. 5 is a flow diagram of an example method 550 corresponding to neuronal to memory device communication in accordance with some embodiments of the present disclosure. The method 550 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 440 is performed by the neuronal component 118 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 552, a plurality of training operations can be performed to train a processing device to recognize that a particular neuronal map is associated with an image. At least one training operation can include sending an instruction to a subject to think of an image or text. The at least one training operation can include recording neuronal activity subsequent to sending the instruction. Further, the at least one training operation can include repeating the sending and the recording until the recorded neuronal activity associated with a same sent image or text is similar across a threshold number of the plurality of training operations.

In some examples, the plurality of training operations can be performed by sending a command to a subject to think of an image in the subject's brain. In some examples, the plurality of training operations can be performed by recording a neuronal map using electrical leads attached to the subject's brain while the subject is thinking of the image. In some examples, the plurality of training operations can be performed by recording a neuronal map using near infrared (IR) on the subject's brain while the subject is thinking of the image.

At block 554, neuronal map data associated with at least one image can be received at a processing device. The neuronal map data can be generated through recording of electrical signals from a user's brain. The electrical signals can be indicative of a neuron or a group of neurons firing in the user's brain. In some examples, the received neuronal map data includes a first neuronal map and a second neuronal map. The first neuronal map can be a password that indicates to display the image and the second neuronal map can represent the image to be displayed. The first neuronal map can be generated in response to a user imagining an additional image different than the image.

In some examples, the received neuronal map data comprises a first set of neuronal maps and a second neuronal map. The first set of neuronal maps represents a password that allows the displaying of the image and the second neuronal map represents the image to be displayed. In some examples, the first set of neuronal maps represents a sequence of images. In some examples, an order of the sequency of images corresponds to whether the password allows the image to be displayed.

At block 556, a determination that the neuronal map data is associated with the at least one image based on the plurality of training operations can be performed. The determination can be based on a number of training operations that were previously performed, as is described above in association with FIG. 2. For example, a database from the training operations can be generated and stored and the associations between particular neuronal maps and particular images can be located in the database and used to make the determination.

At block 558, the at least one image can be displayed in response to the determination. Further, in some examples, the at least one image can be displayed in response to receiving a neuronal map indicative of a password or command indicating to display the image, as is described above. In the absence of the neuronal map associated with the password or command, the image may not be displayed.

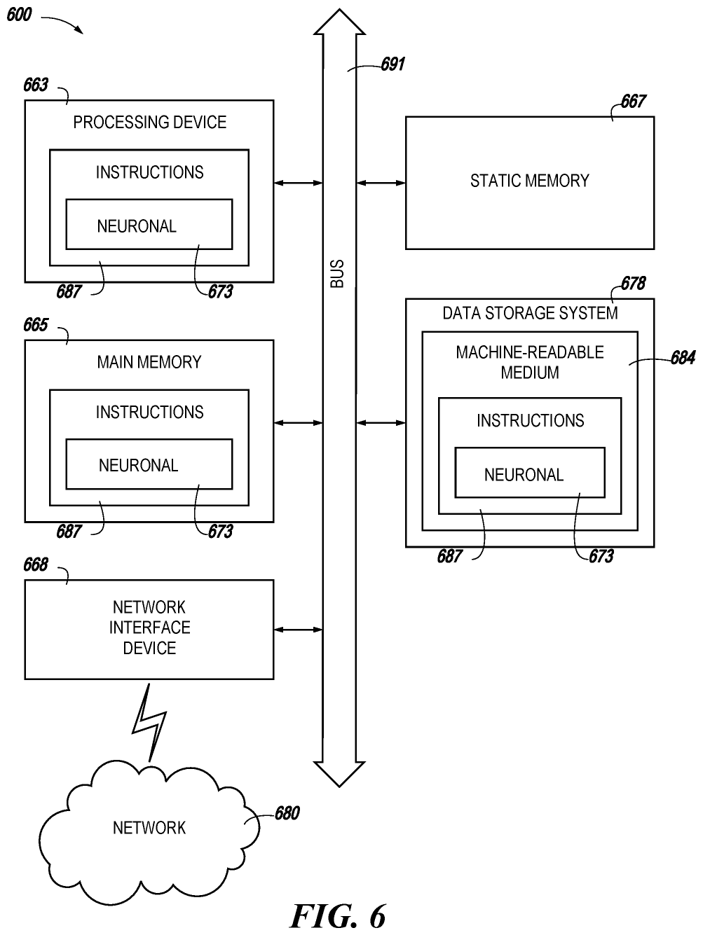

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 102 of FIG. 1) that includes, is coupled to, or utilizes a memory sub-system (e.g., the memory system 104 of FIG. 1) or can be used to perform the operations of a controller (e.g., to perform the neuronal to memory device communication using a neuronal component 118). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 663, a main memory 665 (e.g., read-only memory (ROM), flash memory, dynamic random access memory (DRAM) such as synchronous DRAM (SDRAM) or Rambus DRAM (RDRAM), etc.), a static memory 667 (e.g., flash memory, static random access memory (SRAM), etc.), and a data storage system 678, which communicate with each other via a bus 691.

Processing device 663 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 663 can also be one or more special-purpose processing devices such as an application specific integrated circuit (ASIC), a field programmable gate array (FPGA), a digital signal processor (DSP), network processor, or the like. The processing device 663 is configured to execute instructions 687 for performing the neuronal to memory device communication using a neuronal component 673 and steps discussed herein. The computer system 600 can further include a network interface device 668 to communicate over the network 680.

The data storage system 678 can include a machine-readable storage medium 684 (also known as a computer-readable medium) on which is stored one or more sets of instructions 687 or software embodying any one or more of the methodologies or functions described herein. The instructions 687 can also reside, completely or at least partially, within the main memory 665 and/or within the processing device 663 during execution thereof by the computer system 600, the main memory 665 and the processing device 663 also constituting machine-readable storage media. The machine-readable storage medium 684, data storage system 678, and/or main memory 665 can correspond to the memory sub-system 104 of FIG. 1.

In one embodiment, the instructions 687 include instructions to implement functionality corresponding to neuronal to memory device communication (e.g., using neuronal component 118 of FIG. 1). While the machine-readable storage medium 684 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

Although specific embodiments have been illustrated and described herein, those of ordinary skill in the art will appreciate that an arrangement calculated to achieve the same results can be substituted for the specific embodiments shown. This disclosure is intended to cover adaptations or variations of a number of embodiments of the present disclosure. It is to be understood that the above description has been made in an illustrative fashion, and not a restrictive one. Combination of the above embodiments, and other embodiments not specifically described herein will be apparent to those of ordinary skill in the art upon reviewing the above description. The scope of a number of embodiments of the present disclosure includes other applications in which the above structures and methods are used. Therefore, the scope of a number of embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a memory device; and
a processing device communicatively coupled to the memory device, wherein the processing device is configured to:
receive neuronal map data associated with at least one image;
determine that the neuronal map data is associated with the at least one image; and
display the at least one image in response to the determination.

2. The apparatus of claim 1, wherein the processing device configured to display the at least one image comprises the processing device configured to display a text image.

3. The apparatus of claim 1, wherein the processing device is further configured to perform a plurality of training operations to train the processing device to recognize the at least one image is associated with the neuronal map data.

4. The apparatus of claim 1, wherein the processing device configured to perform the plurality of training operations comprises:
sending an instruction to a subject to think of an image or text;
recording neuronal activity subsequent to sending the instruction; and
repeating the sending and the recording until the recorded neuronal activity associated with a same sent image or text is similar across a threshold number of the plurality of training operations.

5. The apparatus of claim 1, wherein the processing device is configured to, prior to displaying the at least one image, receiving additional neuronal map data associated with a password or permission to display the at least one image.

6. The apparatus of claim 5, wherein the additional neuronal map data is associated with a particular sequence of images.

7. The apparatus of claim 1, wherein the neuronal map data comprises a number of configurations of neuronal activity of a person.

8. An apparatus, comprising:
a memory device; and
a processing device communicatively coupled to the memory device, wherein the processing device is configured to:
perform a plurality of training operations to train the processing device to recognize that a particular neuronal map is associated with an image;
receive neuronal map data associated with the image;
determine that the neuronal map data is associated with the image based on the plurality of training operations; and
display the image in response to the determination.

9. The apparatus of claim 8, wherein:
the received neuronal map data comprises a first neuronal map and a second neuronal map; and
the first neuronal map is a password that indicates to display the image and the second neuronal map represents the image to be displayed.

10. The apparatus of claim 9, wherein the first neuronal map is generated in response to a user imagining an additional image different than the image.

11. The apparatus of claim 9, wherein:
the received neuronal map data comprises a first set of neuronal maps and a second neuronal map; and
the first set of neuronal maps represents a password that allows the displaying of the image and the second neuronal map represents the image to be displayed.

12. The apparatus of claim 11, wherein the first set of neuronal maps represents a sequence of images.

13. The apparatus of claim 12, wherein an order of the sequency of images corresponds to whether the password allows the image to be displayed.

14. The apparatus of claim 8, wherein the processing device is configured to perform the plurality of training operations by sending a command to a subject to think of an image in the subject's brain.

15. The apparatus of claim 14, wherein the processing device is configured to perform the plurality of training operations by recording a neuronal map using electrical leads attached to the subject's brain while the subject is thinking of the image.

16. The apparatus of claim 14, wherein the processing device is configured to perform the plurality of training operations by recording a neuronal map using near infrared (IR) on the subject's brain while the subject is thinking of the image.

17. A method, comprising:
performing a plurality of training operations to train a memory device to correlate each of a plurality of neuronal maps to each of a plurality of images, wherein the plurality of images was thought of while each of the plurality of neuronal maps were recorded;
receiving one of the plurality of neuronal maps generated from recordings of brain activity;
determining that the one neuronal map is associated with an image used as a password or confirmation based on the plurality of training operations; and
displaying the image in response to the determination.

18. The method of claim 17, wherein:
the password is based on a sequence of at least two neuronal maps that correlate to at least two images; and
the password is based on an order of the sequence of the at least two neuronal maps.

19. The method of claim 17, further comprising recording the plurality of neuronal maps by recording a subset of the brain at a particular region.

20. The method of claim 17, wherein the images are one of a text, word, or picture.
